(19) United States
(12) Patent Application Publication
(10) Pub. No.: US 2010/0126359 A1
(43) Pub. Date: May 27, 2010

(54) Multipurpose Apparatus for Juice Extracting and Objects Crushing

(76) Inventor: Guy Bartal, Rishpon (IL)

Correspondence Address: The Law Office of Michael E. Kondoudis, 888 16th Street, N.W., Suite 800, Washington, DC, 20006, US

(21) Appl. No.: 12/323,877

(22) Filed: Nov. 26, 2008

(51) Int. Cl. A23N 1/00; B30B 5/00

(52) U.S. Cl. 99/506; 100/257

(57) ABSTRACT

A multipurpose apparatus that enables extracting juice and crushing objects of variable sizes. The apparatus comprises a base, an approximation mechanism, an upper member, a lower holder member and a support assembly. The upper member and the lower holder member are movably connected to one another through the approximation mechanism, which comprises at least one handle, where the upper member and the lower holder member are movably disposed on the support assembly. A manual lowering of the handle enables the approximation mechanism to approximate the lower holder member to the upper member by simultaneously lifting of the lower holder member towards the upper member and lowering the upper member towards the lower holder member.

### BACKGROUND

1. Field of the Invention

The present invention relates generally to the field of kitchen appliances and more particularly to multipurpose appliances that can extract juice and crush objects.

2. Discussion of Related Art

Crushing of object such as plastic bottles, cans and the like is an efficient way to minimize the space these object usually occupy in your trash bin or any other container for disposing of waste.

Liquid content of plastic bottles, such as a soft drink or even water, for example, is usually consumed by the consumer within a short time span from the purchasing of the drink bottle and the bottle is quickly disposed.

Trash bins used in households are usually too small to contain a large amount of disposed plastic bottles and requires the consumer to frequently empty his/her trash bin due to the quick accumulation of plastic bottles. This may be a tedious task for a heavy plastic bottles' consumer.

Juicers are used for extracting juice from a fruit or a vegetable that is placed therein. The juicer usually comprises a handle that is connected to a lid allowing the lid to be lowered towards a container placed underneath the lid. The container usually has a removable top part which is perforated to allow the juice to be directed into the container. The top is shaped to be received by the lid of the juicer in a manner that enables trapping the fruit part (such as half an orange) between the lid and the top while applying a pushing force (applied by lowering of the handle) thereon and thereby extracting of the juice.

### SUMMARY

A multipurpose apparatus that enables extracting juice and crushing objects of variable sizes is provided.

According to some embodiments, the apparatus may comprise a base, an approximation mechanism, an upper member, a lower holder member and a support assembly.

The upper member and the lower holder member may be movably connected to one another through the approximation mechanism, which comprises at least one handle, where the upper member and the lower holder member are movably disposed on the support assembly.

According to embodiments, a manual lowering of the handle enables the approximation mechanism to approximate the lower holder member to the upper member by simultaneously lifting of the lower holder member towards the upper member and lowering the upper member towards the lower holder member.

The apparatus may enable extracting juice or crushing an objects such as plastic or paper bottles, plastic or paper boxes and the like, by placing a juicer assembly (which usually includes a removable juicer top and container) or an object on the lower holder member and lower the at least one handle to allow the simultaneously lifting of the lower holder member and lowering of the upper member.

The distance between the lower holder member and the upper member may be adjusted according to the size of the object or juicer assembly by lowering and lifting of the lower holder member and upper member using the approximation mechanism.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic illustration of a multipurpose apparatus for extracting juice and crushing objects with a juicer assembly placed therein, where the apparatus is in a half open position, according to some embodiments of the invention;

FIG. 2 is a schematic illustration of the multipurpose apparatus for extracting juice and crushing objects with a juicer assembly placed therein, where the apparatus is in a closed position, according to the embodiments illustrated in FIG. 1;

FIG. 3 is a schematic illustration of a multipurpose apparatus for extracting juice and crushing objects with an object placed therein, where the apparatus is in an open position, according to the embodiments illustrated in FIGS. 1 and 2;

FIG. 4 is a schematic illustration of a multipurpose apparatus for extracting juice and crushing objects with an object placed therein, where the apparatus is in a closed position, according to the embodiments illustrated in FIGS. 1-3; and

FIG. 5 is a schematic illustration of a multipurpose apparatus for extracting juice and crushing objects, according to other embodiments of the invention.

### DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The present invention, according to some embodiments thereof, provides a multipurpose apparatus 100 enabling extracting juice and crushing objects 10′ of variable size, so that the apparatus 100 may be used as a juicer device or as a crushing device by simply placing a juicer assembly 10 or an object 10′ that is to be crushed by the apparatus 100 in the apparatus 100.

The apparatus 100 may be especially but not exclusively adapted to crush objects 10′ such as plastic bottles, plastic boxes, cans, paper bottles or boxes etc.

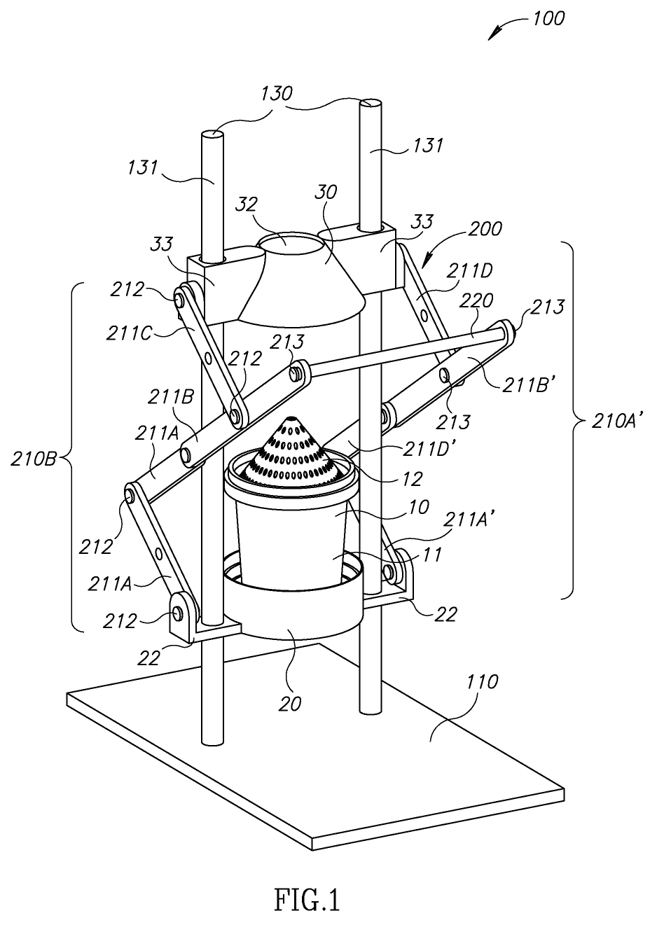

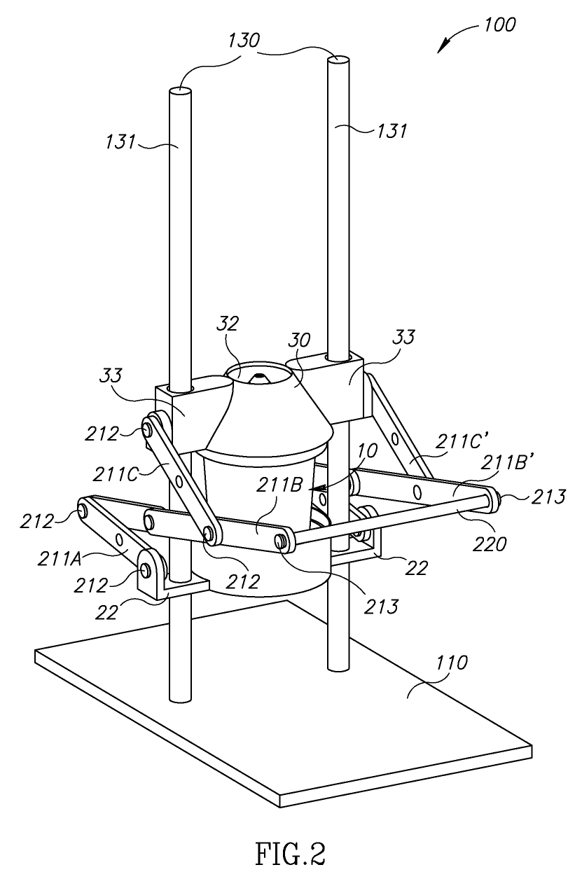

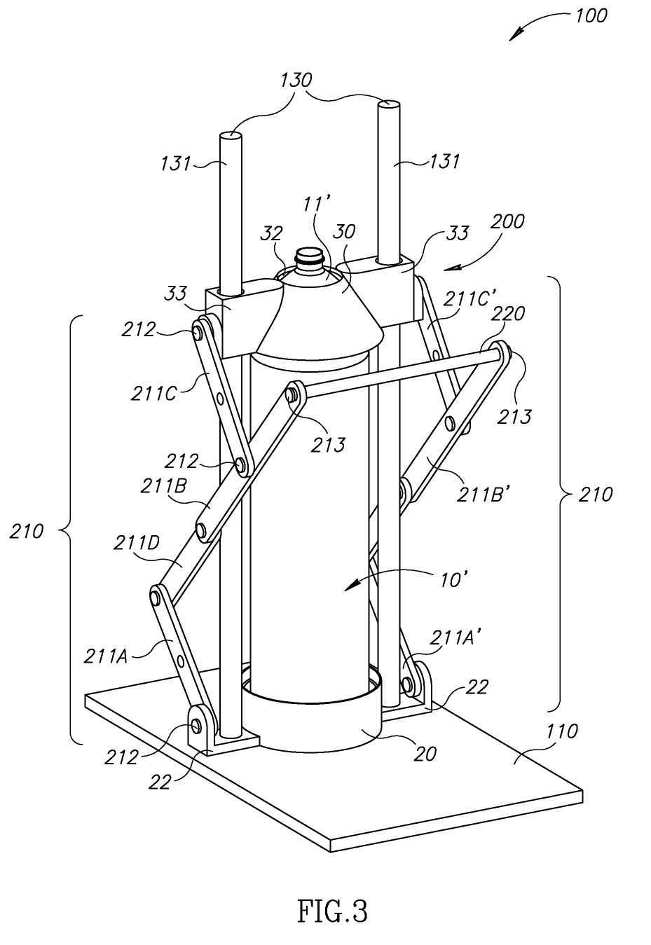

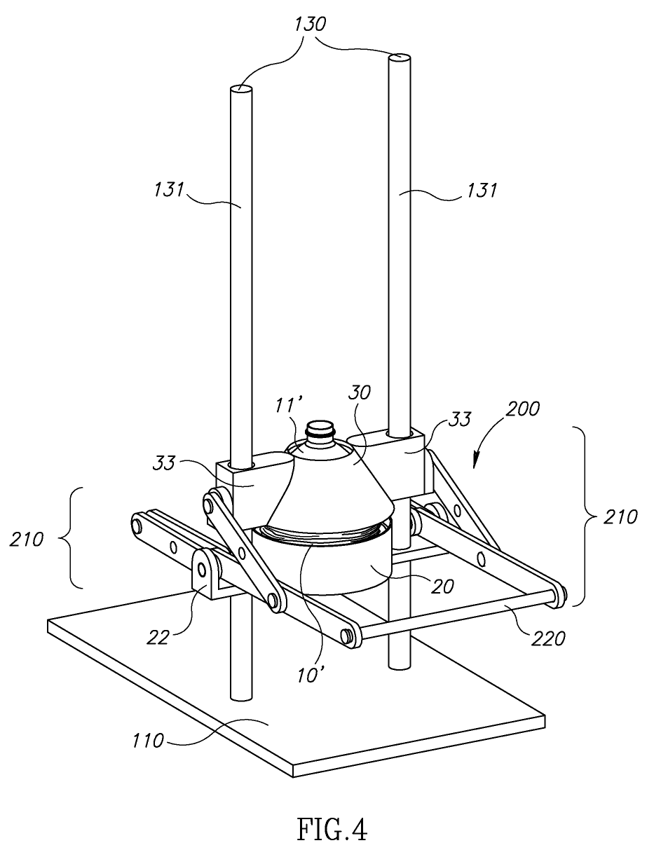

FIG. 1, FIG. 2, FIG. 3 and FIG. 4 all illustrate the multipurpose apparatus 100 at different functionalities and positions, according to some embodiments of the invention.

FIG. 1 is a schematic illustration of the multipurpose apparatus 100 for extracting juice and crushing objects 10′ with a juicer assembly 10′ placed therein, where the apparatus 100 is in a half open position, according to some embodiments.

FIG. 2 is a schematic illustration of the multipurpose apparatus 100 for extracting juice and crushing objects 10′ with a juicer assembly 10 placed therein, where the apparatus 100 is in a closed position, according to the embodiments illustrated in FIG. 1.

FIG. 3 is a schematic illustration of the multipurpose apparatus 100 for extracting juice and crushing objects 10′ with a plastic bottle as the object 10′ placed therein, where the apparatus 100 is in an open position, according to the embodiments illustrated in FIGS. 1 and 2.

FIG. 4 is a schematic illustration of the multipurpose apparatus 100 for extracting juice and crushing objects 10′ with the bottle object 10′ placed therein, where the apparatus 100 is in a closed position, according to the embodiments illustrated in FIGS. 1-3.

According to some embodiments, as illustrated in FIGS. 1-4 the multipurpose apparatus 100 may comprise a base 110, an approximation mechanism 200, an upper member 30, a lower holder member 20 and a support assembly 130.

The base 110 may be of any shape that enables holding the other parts of the apparatus 100 and stabilizing the weight of the apparatus 100, such as, as illustrated in FIGS. 1-4, a rectangular platform, which may have a substantial weight compared to the weight of the other components of the apparatus 100 to serve as a stabilizing member.

According to some embodiments, the support assembly 130 may be connected to the base 110 and the approximation mechanism 200 may be movably disposed on the support assembly 130.

The upper member 30 and the lower holder member 20 may be movably connected to one another through the approximation mechanism 200.

The lower holder member 20 may be a tray shaped placement enabling to simply place the object 10′ or the juicer assembly 10 thereon.

According to embodiments, the upper member 30 may be movably connected to the support assembly 130 through at least one connector 33 and the lower holder member 20 may be movably connected to the support assembly 130 through at least one connector 22, as illustrated in FIG. 1.

According to some embodiments, as illustrated in FIGS. 1-4, the approximation assembly 200 may comprise at least one handle 220 and at least one set of arms 210/210′ (the illustrated embodiments show an example of two sets 210 and 210′), each comprising a multiplicity of arms 211A, 211B and 211C/211A′, 211B′ and 211C′ rotatably connected to one another through joints 212.

Each set 210/210′ of arms 211A, 211B and 211C/211A′, 211B′ and 211C′ may slidably connect to the support assembly 130 directly or through the connectors 22 and 33.

According to embodiments, a manual lowering of the handle 220 (carried out by a user) may enable the approximation mechanism 200 to approximate the lower holder member 20 to the upper member 30 by simultaneously lifting of the lower holder member 20 towards the upper member 30 and lowering of the upper member 30 towards the lower holder member 20.

The apparatus 100 may further enable extracting juice from a fruit part or a vegetable (e.g. a sliced part of an orange, a lemon, a grapefruit etc.) or crushing an object 10′ (e.g. a plastic bottle, a can, plastic box etc.) by placing a juicer assembly 10 or an object 10′ on the lower holder member 20 and levering the juicer assembly 10 or object 10′ towards the upper member 30 and the upper member 30 towards the juicer assembly 10 or the lower part of the object 10′ (which means lowering towards the lower holder member 20, as illustrated in FIGS. 1-4.

According to embodiments, as illustrated in FIGS. 1-4, the distance “D” between the lower holder member 20 and the upper member 30 can be adjusted according to the size of the object 10′ or juicer assembly 10 by lowering and lifting of the lower holder member 20 and the upper member 30, using the approximation mechanism 200 (by lowering or lifting the handle 220).

According to some embodiments, as illustrated in FIG. 1, each set 210/210′ of arms 211A, 211B and 211C/211A′, 211B′ and 211C′ may be connected to one side of the upper member 30 at one upper end of the set 210/210′ and to one side of the lower holder member 20 at another lower end of the set 210/210′.

According to embodiments, the handle 220 may connect the two sets 210/210′ to one another in a manner that when the handle 220 is manually lowered it enables the arms 211A, 211B and 211C/211A′, 211B′ and 211C′ of the two sets 210/210′ to fold towards one another and thereby to lift the lower holder member 20 to approximate the lower holder member 20 towards the upper member 30 and simultaneously to lower the upper member 30 to approximated it to the lower holder member 20.

According to embodiments, as illustrated in FIGS. 1-4, each set 210/210′ of arms 211A, 211B and 211C/211A′, 211B′ and 211C′ may comprises at least three arms: an upper arm 211C/211C′, a middle arm 211B/211B′ and a lower arm 211A/211A′. The lower part of the upper arm 211C/211C′ may be rotatably connected to the upper part of the middle arm 211B/211B′ through a joint 212, the upper part of the upper arm 211C/211C′ may be rotatably connected to one of the upper member's 30 connector 33 through a joint 212, the lower part of the middle arm 211B/211B′ may be rotatably connected to the upper part of the lower arm 211A/211A′ through a joint 212, the middle part of the middle arm 211B/211B′ may be connected to one of the at least one handle 220 (e.g. through a joint 212), the lower part of the middle arm 211B/211B′ may be rotatably connected to the upper part of the lower arm 211A/211A′ and the lower part of the lower arm 211A/211A′ may be rotatably connected to one of the lower holder member's 20 connector 22 through a joint 22.

According to embodiments, as illustrated in FIGS. 1-4, the support assembly 130 may comprise two cylindrical rods 131, substantially parallel to one another and perpendicularly connected to the base 110, enabling the connectors 22 and 33 that connect to the sets 210/210′ of arms 211A, 211B and 211C/211A′, 211B′ and 211C′ to the lower holder member 20 and to the upper member 30 to slide along the rods 131, by having rounded holes perforated through the connectors 22 and 33 through which each rod 131 can be inserted.

The maximal distance between the lower holder member 20 and the upper member 30, which determines the maximal height of the object 10′ placed therebetween, may be adjustable. According to embodiments, the adjustment may be enabled by adjusting the positioning of the upper member 30 along the support assembly 130, which may be enabled by movably connecting of the upper member 30 to the support assembly 130 at a desirable distance from the base, using the connectors 33, wherein the connectors are removable.

According to embodiments, as illustrated in FIGS. 1 and 2, the juicer assembly 10 may comprise a container 11 and a juicer top 12 adapted in size and shape to be placed upon the container 11 as a top. The juicer top 12 may comprise holes or an opening through which the juice of the fruit can be directed into the container 11, as known in the art. To facilitate the juicing, the top 12 may have a roughened surface, as known in the art.

The juicer assembly 10 may be placed upon the lower holder member 20 of the apparatus 100 to allow using it as a juicer.

The size and hence the volume of the juicer assembly's container 10 can be adjusted according to the desired quantity of juice and according to the maximal distance between the lower holder member 20 and the upper member 30.

According to embodiments, as illustrated in FIGS. 1-4, the upper member 30 may be a lid, shaped as a trimmed cone having an opening 32, where the trimmed cone shape of the upper member 30 and the opening 30 may be adapted to receive an upper part 11′ of a standard sized bottle object 10′, as illustrated in FIGS. 3-4 as well as the juicer top 12 of the juicer assembly 10, as illustrated in FIGS. 1 and 2.

According to embodiments, the apparatus 100 may be provided with a multiplicity of upper members 30 of variable sizes and shapes, which allow adapting the size and shape of the upper member 30 to the upper part of the object 10′ or the size and shape of the juicer assembly 10.

According to some embodiments, the apparatus 100 may be further provided with a multiplicity of lower holder members 20 of different sizes and shapes to allow adapting it to various objects 10′ and/or juicer assemblies 10 sizes and shapes.

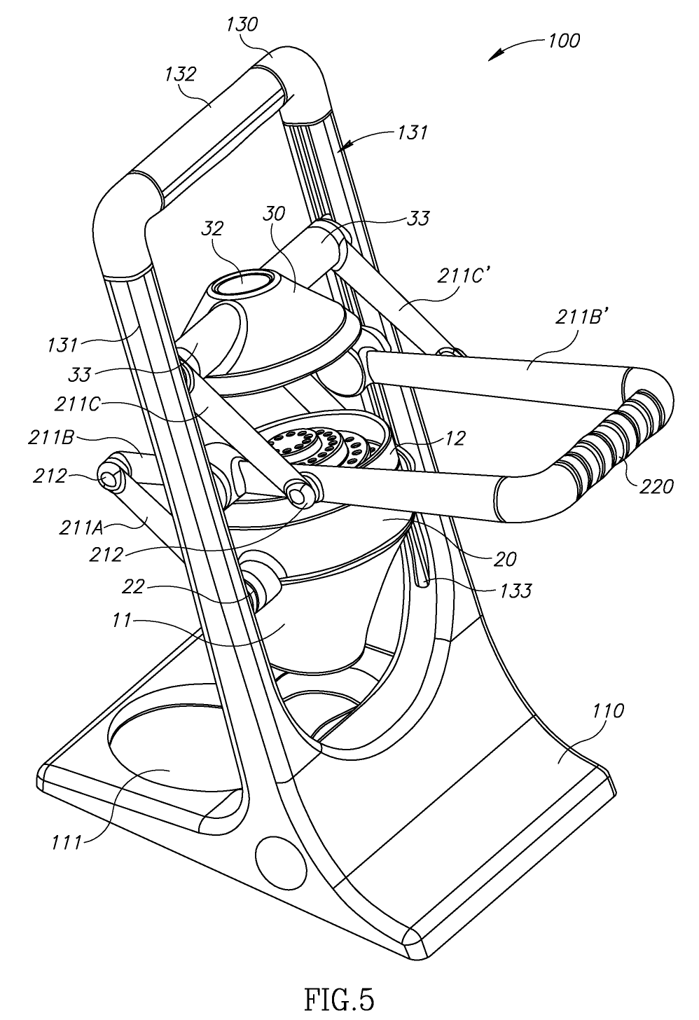

FIG. 5 is a schematic illustration of a multipurpose apparatus 100 for extracting juice and crushing objects 10′, according to other embodiments of the invention.

According to these embodiments, the support assembly 130 may comprise a support handle 132 and the two rods 131, where the support handle 132 connects the top end of the rods 131, to allow the user to stabilize the apparatus 100 when extracting juice or crushing an object 10′ by holding the support handle 132.

According to the other embodiments, as illustrated in FIG. 5, the base 110 of the apparatus 100 may include at least one niche 111 for receiving the container 11 of the juicer assembly 10, where the lower holder member 20 may be an encircling member (e.g. a flat ring) enabling to hold the container 11 or the object 10′ by tightly encircling the outer surface of the container 11 or object 10′.

According to embodiments, the container 11 may be integrally connected to the encircling lower holder member 20 where to crush an object 10′ the object's 10′ lower part may be received by the integrated container 11 and lower holder member 20.

According to embodiments, the container 10, integrally connected to the ring shaped lower holder member 20 may enable receiving a juicer top 12 as a cover, as illustrated in FIG. 5.

According to embodiments, as illustrated in FIG. 5, each of the support rods 131 may include a track like groove 133 curved along the inner side of each rod 131 enabling the connectors 22 and 33 of each side of the lower holder member 20 and upper member 30, respectively, to be inserted into the grooves 133 and to slide along the grooves 133 and thereby allow the approximation mechanism 200 to move along the support assembly 130.

Additionally, at least one of the arms 211B and 211B′ of each set 210 and 210′ may comprise an additional connector 21 enabling the arms 211B and 211B′ to also slide along the grooves 133 of the rods 131.

While the invention has been described with respect to a limited number of embodiments, these should not be construed as limitations on the scope of the invention, but rather as exemplifications of some of the embodiments thereof, including a preferred embodiment. The scope of the invention should not be limited by what has been described, but by the appended claims and their legal equivalents.

What is claimed is:

1. A multipurpose apparatus enabling extracting juice and crushing objects of variable sizes, the apparatus comprising;
a base;
an approximation mechanism;
an upper member; and
a lower holder member and a support assembly,
wherein the support assembly is connected to the base and the approximation mechanism is movably disposed on the support assembly,
wherein the upper member and the lower holder member are movably connected to one another through the approximation mechanism,
wherein the approximation mechanism comprises at least one handle,
wherein a manual lowering of the handle enables the approximation mechanism to approximate the lower holder member to the upper member by simultaneously lifting of the lower holder member towards the upper member and lowering the upper member towards the lower holder member, and
wherein the apparatus enables extracting juice or crushing an object by placing a juicer assembly or an object on the lower holder member and lower the at least one handle to allow the simultaneously lifting of the lower holder member and lowering of the upper member.

2. The apparatus of claim 1, wherein the approximation mechanism further enables adjusting the distance between the lower holder member and the upper member according to the size of the object or juicer assembly by lowering and lifting of the lower holder member.

3. The apparatus of claim 1, wherein the approximation mechanism comprises one handle and two sets of arms each comprising a multiplicity of arms rotatably connected to one another through joints,
wherein each set of arms is further rotatably connected to one side of the upper member at one upper end of the set and to one side of the lower holder member at another lower end of the set, and
wherein the handle connects the two sets of arms to one another in a manner that when the handle is manually lowered it enables the arms of the two sets to fold towards one another and thereby to lift the lower holder member to approximate the lower holder member towards the upper member and simultaneously lower the upper member towards the lower holder member.

4. The apparatus of claim 3, wherein each set of arms comprises at least an upper arm, a middle arm, and a lower arm,
wherein the lower part of the upper arm is rotatably connected to the upper part of the middle arm through a joint, the upper part of the upper arm is rotatably connected to one side of the upper member through a joint, the lower part of the middle arm is rotatably connected to the upper part of the lower arm through a joint, the middle part of the middle arm is connected to one side of the at least one handle, the lower part of the middle arm is rotatably connected to the upper part of the lower arm and the lower part of the lower arm is rotatably connected to one side of the lower holder member through a joint.

5. The apparatus of claim 4, wherein the support assembly comprises two cylindrical rods, substantially perpendicularly connected to the base, enabling connectors, movably connecting the lower holder member and the upper member to the support assembly and to the arms of the sets through the joints, to slidably connect the lower holder member and the upper member to the rods by having rounded holes perforated therethrough, through which each rod is inserted allowing the connectors to slide along the rods.

6. The apparatus of claim 5, wherein the maximal distance between the lower holder member and the upper member, which determines the maximal height of the object placed therebetween, is adjustable, and
wherein the adjustment is enabled by adjusting the positioning of the upper member along the support assembly, which is enabled by connecting of the upper member to support assembly at a desirable distance from the base, using the connectors, wherein the connectors are removable.

7. The apparatus of claim 4, wherein the support assembly comprises two rods, substantially perpendicularly connected to the base, enabling connectors, movably connecting the lower holder member and the upper member to the support assembly and to the arms of the sets through the joints, to slidably connect the lower holder member and the upper member to the rods by having holes perforated therethrough, through which each rod is inserted allowing the connectors to slide along the rods.

8. The apparatus of claim 1, wherein the upper member is a lid, shaped as a trimmed cone having an opening, and
wherein the size of the trimmed cone and the size of the opening allow receiving of a top part of a standard size bottle.

9. The apparatus of claim 8, further comprising a multiplicity of upper members of variable sizes and shapes, which allow adapting the size and shape of the upper member to the upper part of the object or the size and shape of the juicer.

10. The apparatus of claim 1, further enabling using the apparatus a juicer, by placing a juicer assembly comprising a container and a juicing cap, upon the lower holder member.

11. The apparatus of claim 10, wherein a size and a volume of the juicer assembly's container can be adjusted according to the desired quantity of juice and according to the maximal distance between the lower holder member and the upper member.

12. The apparatus of claim 1, wherein the approximation mechanism comprises one handle and at least one set of arms comprising a multiplicity of arms rotatably connected to one another through joints,
wherein each set of arms is further rotatably connected to one side of the upper member at one upper end of the set and to one side of the lower holder member at another lower end of the set,
wherein the handle connects the two sets of arms to one another in a manner that when the handle is manually lowered it enables the arms of the two sets to fold towards one another and thereby to lift the lower holder member to approximate the lower holder member towards the upper member and simultaneously lower the upper member towards the lower holder member, and
wherein the lower holder member is an encircling member enabling to tightly encircle the container and thereby to hold the container therein.

13. The apparatus of claim 12, wherein the base further comprises at least one niche that enables receiving the lower part of the container.

14. The apparatus of claim 12, wherein the container and lower holder member are integrally connected.

15. The apparatus of claim 14, wherein the container enables receiving a juicer top as a cover for extracting of juice.

16. The apparatus of claim 12, wherein the support assembly comprises two support rods and a support handle, wherein the support handle connects the top ends of the rods.

17. The apparatus of claim 16, wherein each of the support rods includes a groove curved along the inner side of each rod enabling connectors, movably connecting the lower holder member and the upper member to the support assembly by enabling the connectors to be slidably inserted into the grooves and thereby to slide along the grooves.

18. The apparatus of claim 17, wherein at least one of the arms of the at least one set of arms comprises an additional connector enabling that arm to also slide along the grooves of the rods.
